(19) United States
(12) Patent Application Publication
(10) Pub. No.: US 2016/0066055 A1
(43) Pub. Date: Mar. 3, 2016

(54) METHOD AND SYSTEM FOR AUTOMATICALLY ADDING SUBTITLES TO STREAMING MEDIA CONTENT

(71) Applicant: Igal NIR, Lehavim (IL)

(72) Inventor: Igal NIR, Lehavim (IL)

(21) Appl. No.: 14/779,579

(22) PCT Filed: Mar. 20, 2014
(86) PCT No.: PCT/IL2014/050306

§ 371 Date: Sep. 24, 2015

(30) Foreign Application Priority Data
Mar. 24, 2013 (IL) 225480

(51) Int. Cl. H04N 21/488; G10L 15/05; H04N 21/43; H04N 21/44; H04N 21/439; H04N 21/485; H04N 21/422; H04N 7/088; H04N 21/84; G10L 15/26; H04N 21/475

(52) U.S. Cl. CPC H04N 21/4884; G10L 15/26; G10L 15/05; H04N 21/4302; H04N 21/44004; H04N 21/4755; H04N 21/4856; H04N 21/42203; H04N 7/0885; H04N 21/84; H04N 21/439

(57) ABSTRACT

A video subtitling hardware device for automatically adding subtitles in a destination language comprising (a) a CPU for processing a stream of separate audio and video signals which are received from the audio-visual source and are subdivided into a plurality of predefined time slices! (b) an audio buffer for temporarily storing time slices of the received audio signals which are representative of one or more words to be processed by the CPU! (c) a speech recognition module for converting the outputted audio signals to text in the source language! (d) a text to subtitle module for converting the text to subtitles by generating an image containing one or more subtitle frames! (e) an input video buffer for temporarily storing each time slice of the received video signals for a sufficient time needed to generate one or more subtitle frames and to merge the generated one or more subtitle frames with the time slice of video signals! (f) an output video buffer for receiving video signals outputted by the input video buffer concurrently to transmission of additional video signals of the stream to the input video buffer, in response to flow of the outputted video signals to the output video buffer! (g) a layout builder for merging one or more of the subtitle frames with a corresponding image frame to generate a composite frame! (h) a synchronization module for synchronizing between each group of composite frames and their corresponding time slices of a sound track associated with the audio signal before outputting the synchronized composite frame group and audio channel to the video display.

### FIELD OF THE INVENTION

The present invention relates to the field of generating multimedia subtitles. More particularly, the invention relates to a method and system for automatically adding subtitles to a streamed media content such as TV programs, broadcasted by a set-top box.

### BACKGROUND OF THE INVENTION

Subtitling and closed captioning are both processes of displaying text on a television, video screen, or other visual display to provide additional or interpretive information. Closed captions typically show a transcription of the audio portion of a program as it occurs.

Closed captioning was developed to aid hearing-impaired people, but it is also useful for a variety of situations. For example, captions can be read when the audio part cannot be heard, either because of a noisy environment or because of an environment that must be kept quiet.

Also, the growing need to watch global video content and TV programs requires online translation of subtitles to the local language. Since such translation is not always available, TV stations or content providers sometimes exclude some programs from the broadcasting list. As a result, the users miss high quality programs which can be interesting for them.

Also, hearing-impaired people who are interested in watching TV programs are actually limited only to programs with inherent (pre-prepared) subtitles or translation, as well as translation to the sign language. However, usually translation to the sign language is cumbersome and is limited only to short programs, such as news.

Seeing-impaired people who are interested in watching TV programs are also limited, since inherent subtitles or translation are pre-prepared to a specific font size, which they cannot see.

WO 02/089114 discloses a system for receiving live speech or motion picture audio, converting the speech to text, and transferring the text to a user. The speech or text can be translated into one or more different languages, where conversion and transmission of speech and streaming text may be provided in real-time on separate channels, as desired. Different captioning protocols are converted to standard format text.

US 2007/0118373 discloses a system for generating closed captions from an audio signal, which includes an audio pre-processor that is configured to correct undesirable attributes from an audio signal and to output speech segments. The system also includes a speech recognition module that configured to generate text transcripts from the speech segments and a post processor that is configured to provide pre-selected modification to the text transcripts. An encoder is configured to broadcast modified text transcripts that correspond to the speech segments as closed captions.

It is an object of the present invention to provide a system, which allows online generation and addition of subtitles to the broadcasted video, according to the audio track that accompanies the broadcasted video.

It is another object of the present invention to provide a system, which allows online generation and addition of translated subtitles to the broadcasted video, according to the user's preference.

Other objects and advantages of the invention will become apparent as the description proceeds.

### SUMMARY OF THE INVENTION

The present invention is directed to a video subtitling device that is interposed between an audio-visual source or a Set-Top Box (STB) and a video display such as a TV, for automatically adding subtitles in a destination language, to received video signals accompanied by corresponding audio signals. The proposed device preferably comprises:

a) a CPU for processing the received audio and video signals;

b) an input video codec for capturing the video signals (e.g., in HDMI or DVI formats) from the STB and forwarding them to the CPU, for processing;

b) an input audio Codec for capturing the audio signals from the STB and injecting them to the CPU, for processing;

c) a memory (such as flash memory and/or a hard-disk) for storing processing results provided by the CPU;

d) an audio buffer for temporarily storing predetermined time slices of audio signals containing one or more words to be processed by the CPU, such that neighboring time slices of audio signals overlap each other by a predetermined duration;

e) a speech recognition module for converting each audio time slice to text that contains the transcription of the audio time slice;

f) a text to subtitles module for converting the text to subtitles by generating an image containing a subtitle frame including subtitles of the text;

g) a video buffer for temporarily storing predetermined time slices of video signals to be processed by the CPU and for which the same subtitle is presented, such that neighboring time slices of video signals overlap each other by a predetermined duration;

h) a layout builder for generating a subtitle frame that contains a corresponding subtitle and for merging the subtitle frame with the image frame;

i) a synchronization module for synchronizing between each group of merged frames and their corresponding audio time slice by introducing a the desired delay to the corresponding audio time slice introducing some delay to the video of audio channel before outputting it to the video display;

j) an output video Codec for capturing the processed video signals that include the added subtitles from the CPU and for transmitting them to the video display; and

k) an output audio Codec for capturing the audio signals with or without delay, from the CPU and for transmitting them to the video display, such that both signals are synchronized.

The proposed video subtitling device may be programmed to generate subtitles in any predetermined language and appearance and may further comprise user interface elements for allowing a user to configure it to operate according to user predetermined preferences such as destination language, subtitle font size, contrast and graphical properties of the subtitles.

The user interface elements may include a touch screen control unit for controlling the operating menus, a display for displaying configuring menus and statuses to the user, a mouse and a keyboard for allowing the user to input and select desired preferences, an IR controller for allowing the user to control the subtitling hardware device, a microphone for allowing the user to control the subtitling hardware device by voice commands, a loudspeaker for playing speech originated from conversion of the subtitles to voice and voice indications during the configuration process of the user and a Wi-Fi receiver for upgrading versions of the operating software via the internet extracting words in destination languages from an external database and connecting to an external processing cloud.

The video subtitling device may further comprise:
a memory for storing a database of destination languages;
a translation module for generates a corresponding text in a destination language configured by the user;
a subtitle detector for detecting if an image frame already contains a subtitle;

The user interface may allow determining the time slice duration, according to the desired length of subtitles.

The present invention is also directed to a video s method for automatically adding subtitles in a destination language, to received video signals accompanied by corresponding audio signals associated with a source language, comprising the following steps:

a) processing a stream of separate audio and video signals which are received from the audio-visual source and are subdivided into a plurality of predefined time slices, by a CPU;

b) temporarily storing in an audio buffer, a predetermined number of time slices of the received audio signals which are representative of one or more words to be processed by the CPU, such that neighboring time slices of audio signals outputted by the audio buffer overlap each other by a predetermined duration of more than one half of a maximum articulation time for articulating a longest word of the audio signals in the source language that has been processed until a given time by the CPU in the received stream;

c) converting the outputted audio signals to text in the source language by a speech recognition module, at each predetermined interval of the audio signals;

d) converting the text to subtitles by generating an image containing one or more subtitle frames, each of the subtitle frames including at least one subtitle converted from the text, wherein the CPU is operable to assign combined cut words of the text, if any, to one of a first subtitle frame and a second subtitle frame subsequent to the first subtitle frame while ensuring that only complete words are displayed in the first and second subtitle frames;

e) temporarily storing, in an input video buffer, each time slice of the received video signals for a sufficient time needed to generate one or more subtitle frames and to merge the generated one or more subtitle frames with the time slice of video signals;

f) receiving video signals outputted by the input video buffer, in an output video buffer, concurrently to transmission of additional video signals of the stream to the input video buffer, in response to flow of the outputted video signals to the output video buffer;

g) merging one or more of the subtitle frames with a corresponding image frame to generate a composite frame; and

h) synchronizing between each group of composite frames and their corresponding time slices of a sound track associated with the audio signal before outputting the synchronized composite frame group and audio channel to the video display.

A corresponding text may be generated in a destination language that may be configured by the user, who can also determine the time slice duration, according to the desired length of subtitles.

Whenever the image frame already contains a subtitle, the original image frames are directly forwarded to the synchronization module for synchronization, with no change, while bypassing the layout builder.

### BRIEF DESCRIPTION OF THE DRAWINGS

In the drawings:

FIG. 1A illustrates the general concept of integrating the subtitling hardware device to an existing video broadcasting system;

FIG. 1B is a general illustration of the operation of the subtitling hardware device of the present invention;

FIG. 2 is a block diagram of the subtitling hardware device of the present invention;

FIG. 3 illustrates the steps of the subtitling process, performed by the hardware device according to one embodiment of the present invention; and

FIG. 4 illustrates the steps of the subtitling process, performed by the hardware device according to another embodiment of the present invention.

### DETAILED DESCRIPTION OF PREFERRED EMBODIMENTS

The present invention is a hardware subtitling device that that is interposed between the Set-Top Box (STB), or between any other audio-visual source that transmits a video stream or video content to a video monitor, such as a TV, and the TV. The inventive hardware subtitling device is adapted to read and decode the sound track that accompanies the video stream to be displayed on the TV screen and to automatically generate a transcript that corresponds to a scene consisting of a predetermined group of video frames using a speech recognition module. After that, the transcript may be automatically translated to a different language, if desired by the user, and then the hardware subtitling device is adapted to generate a subtitle that corresponds to the scene in the original language or in another language (after translation). The generated subtitle is added to the scene as an additional video layer and displayed during the entire scene, or any portion thereof. This process is repeated for the entire video stream, where the subtitling hardware synchronizes between the video scene and its corresponding subtitle by delaying the sound track. The subtitling hardware device operates independently and should not be synchronized to the TV or to the set-top box.

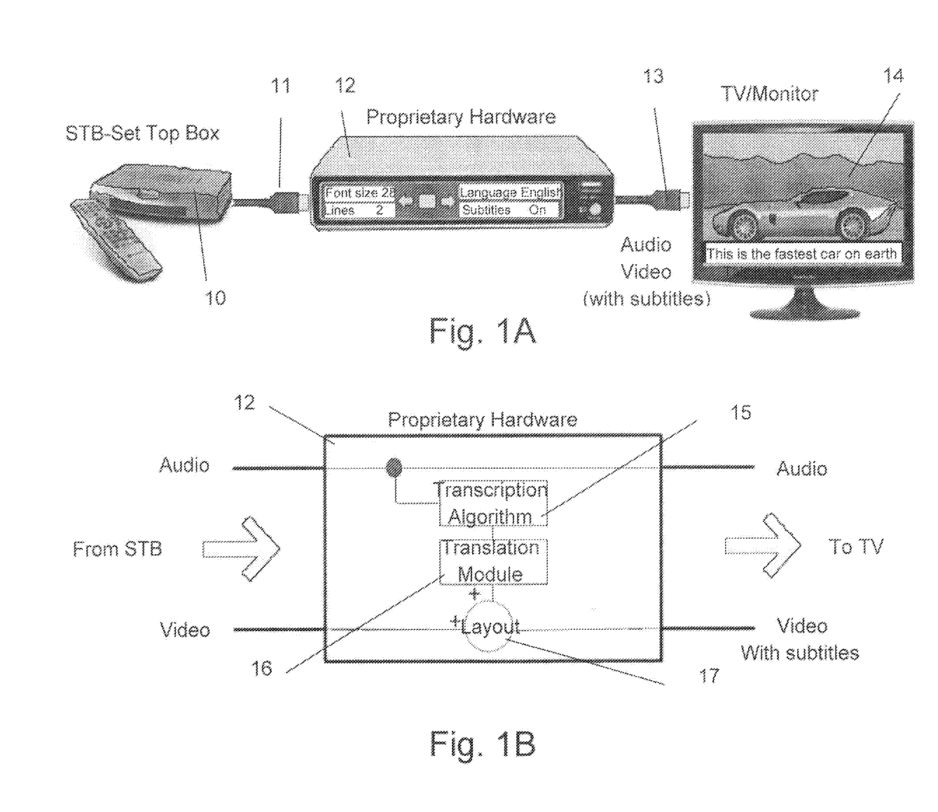

FIG. 1A illustrates the general concept of integrating the subtitling hardware device to an existing video broadcasting system. The subtitling hardware device 12 receives the original video stream and its accompanying audio signal from the STB 10 via audio/video cable 11, processes the audio signals, generates and adds subtitles and outputs a composite video signal that includes the original video stream with the generated subtitles, along with the original audio signal into the TV monitor 14 via audio/video cable 13.

FIG. 1B is a general illustration of the operation of the subtitling hardware device of the present invention. The subtitling hardware device 12 includes a transcription module that receives the audio signal and generates a text from it, which is then translated (if desired) by a translation module 16. The text is then converted to subtitles in a separate video layer. The subtitle video layer is added to the original video stream by a layout module 17, to generate the composite video signal, synchronized with the audio signal, which is input into the TV along with the original audio signal.

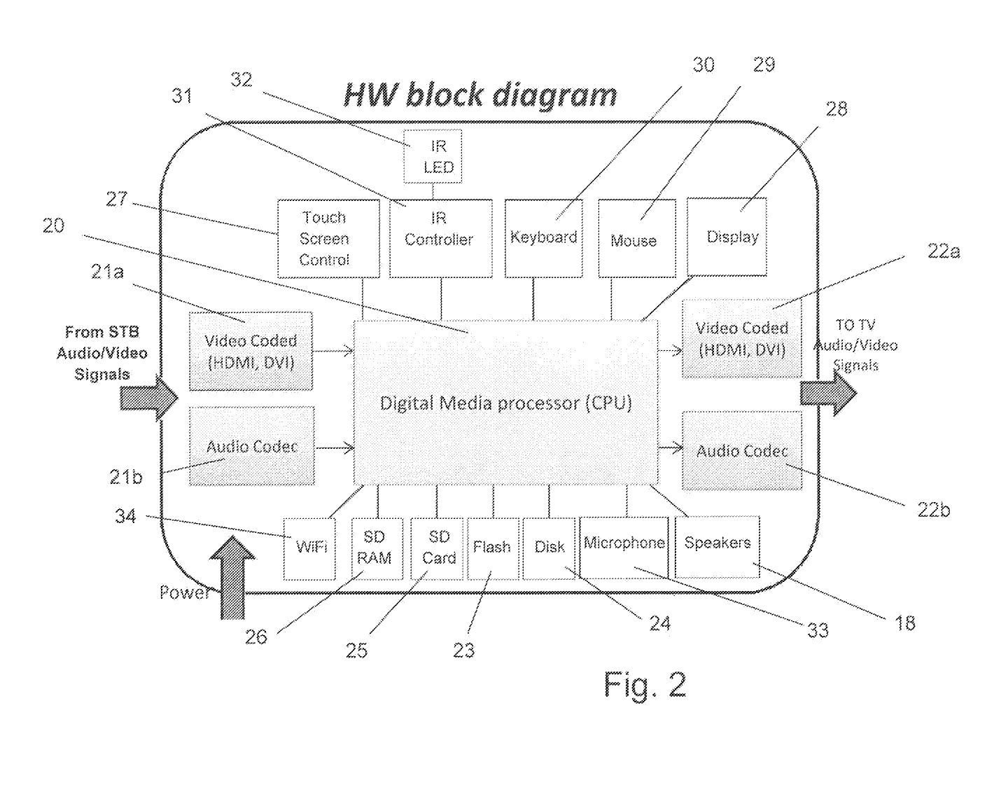

FIG. 2 is a block diagram of the subtitling hardware device, according to one embodiment of the present invention. The subtitling hardware device 12 includes a CPU 20 (such as a digital media processor manufactured by Texas Instruments or Intel) for processing the received audio and video signals and for controlling the operation of the subtitling hardware device 12, to carry out the process of automatically adding subtitles to the received video signal.

An input video codec (capable of encoding or decoding the received video stream signal) 21a captures the video signals from the STB and forwards them to the CPU 20, for processing. The input video codec 21a is adapted to receive and process video signals in any standard format, such as High-Definition Multimedia Interface (HDMI), Digital Visual Interface (DVI) etc. Generally, the subtitling hardware device 12 comprises several input connectors for each cable that is used to connect the STB 20, such that the CPU 20 of will get an indication regarding the video format according to the cable type that has been connected.

An input audio Codec 22a (capable of encoding or decoding the received audio signal) captures the audio signals from the STB and injects them to the CPU 20, for processing.

The software or firmware required for processing, as well as the parameters required for determining the generated subtitles and backups are stored in a non-volatile memory, such as a flash memory 23. A hard-disk 24 is used as a database for storing vocabulary words for each of one or more languages, as well as instructions for translating words from a source language to a destination language. An external storage such as an SD Card may also be used as a database and for upgrading the operating firmware. The CPU 20 loads data to be processed to a volatile memory, such as a Synchronous Dynamic Random Access Memory 26 (SDRAM with a synchronous interface and therefore, is synchronized with the bus of the subtitling hardware device 12), so as to accelerate processing time.

An output video Codec 21b captures the processed video signals that include the added subtitles from the CPU 20 and transmits them to the TV monitor. An output audio Codec 22b captures the audio signals with or without delay, from the CPU 20 and transmits them to the TV monitor, such that both signals are synchronized.

The basic version of the subtitling hardware device 12 includes dedicated hardware that is programmed to generate subtitles in a predetermined language and appearance. As long as the subtitling hardware device 12 is in its OFF state, no subtitles will be added and the video and audio signals will pass from the STB 10 to the TV with no change. When the user will turn it ON, the subtitles will be automatically generated in the predetermined language and appearance. However in its more advanced version, the subtitling hardware device 12 may further include User Interface (UI) elements for allowing to user to configure it to operate according to predetermined preferences, such as destination language, subtitle font size, contrast and graphical properties of the subtitles. The UI may include a touch screen control unit 27 for controlling the operating menus via a touch screen. Other interface elements may be an LCD or LED display, for displaying configuring menus and statuses to the user. The user can also configure the device using a mouse 29 and a keyboard 30. An IR controller 31 allows the user to control the subtitling hardware device 12 by a remote control device which transmits commands that are received by an IR LED receiver 32 and forwarded to the IR controller 31. A microphone 33 allows the user to control the subtitling hardware device 12 by voice commands, since it comprises a speech recognition module. The subtitling hardware device 12 may comprise a loudspeaker 18 for playing speech originated from conversion of the subtitles to voice, which may replace the TV speaker or may be heard in addition to it. The loudspeaker 18 may be also used to play voice indications during the configuration process of the user, such as beeping when there is an error or when a configuration step has been successfully completed.

The subtitling hardware device 12 may also comprise a Wi-Fi receiver 34 that allows upgrading versions of the operating software via the Internet (or other data networks). The Wi-Fi receiver 34 may also be used for extracting words in various destination languages from an external database and for connecting the subtitling hardware device 12 to an external processing cloud (an external network that may provide data and computational services).

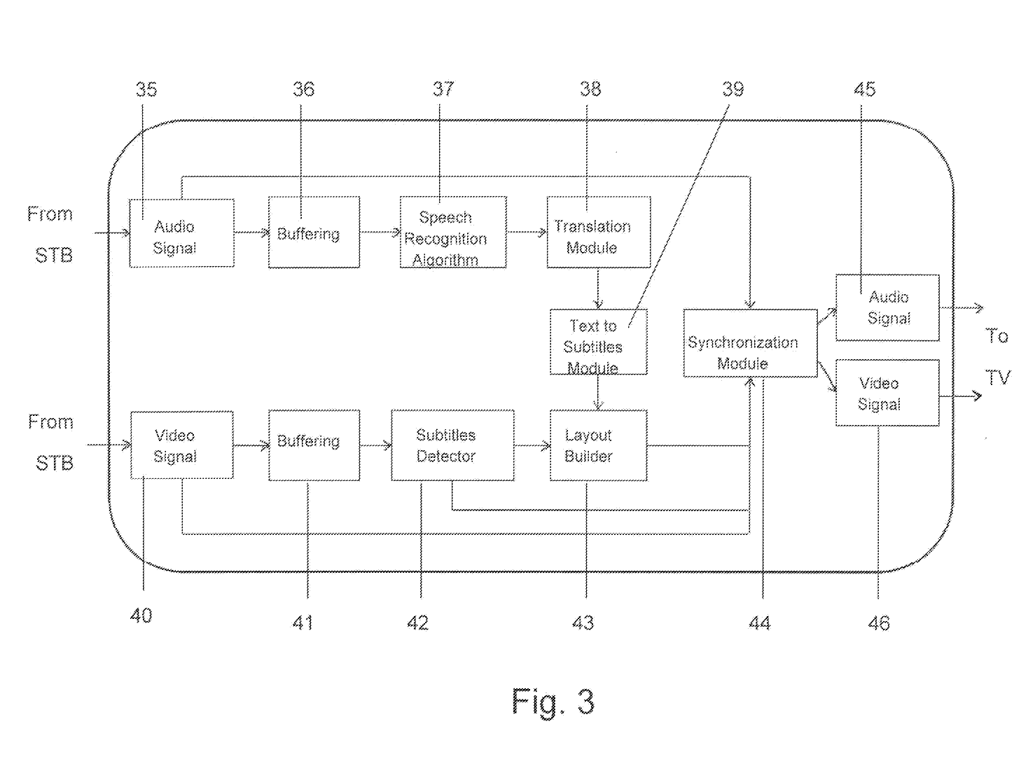

FIG. 3 illustrates the steps of the subtitling process, performed by the hardware device, according to an embodiment of the present invention. At the first step, the audio signal 35 received from the STB 10 is forwarded to an audio buffer 36, in which a time slice of X seconds (2<X<10, depending on a selected configuration) that normally includes several words to be processed by the CPU 20 is temporarily stored. Assuming that the duration of a word is time limited (e.g., less than 2 seconds), neighboring time slices of audio signals are designed to overlap each other by 1 Sec, so as to avoid rectification in the middle of a word. At the next step, a speech recognition module 37 converts each audio time slice to text that includes the transcription of the audio time slice. At the next step, a translation module 38 generates a corresponding text in the destination language (configured by the user). At the next step, a text to subtitles module 39 converts the translated text to subtitles by generating an image containing a frame with subtitles with the text with the desired translated language.

In parallel to buffering the audio signal 35, the video signal 40, received from the STB 10, is forwarded to a video buffer 41, in which a time slice of X seconds (2<X<10, depending on a selected configuration) to be processed by the CPU 20 is temporarily stored, such that each time slice X contains Y image frames (Y=X·fps| frames per second) that are temporarily stored within the video buffer 41, and for which the same subtitle is presented. Neighboring time slices of video signals are designed to overlap each other by 1 Sec, so as to avoid rectification in the middle of a video segment. A subtitle detector 42 detects for each image frame within the video buffer 41, whether or not this image frame already contains a subtitle.

In one embodiment, the user will be able to determine the time slice X, according to the desired length of subtitles. A longer time slice X will result in a longer subtitle text and in some cases, more than one row, depending on the desired font size. This option is more suitable for users that can see subtitles with a relatively small font size. On the other hand, a short time slice X will result in a shorter subtitle text which will be presented normally on one row, depending on the desired font size. In this case for example, a seeing-impaired user will be able to increase the font size, such that a smaller value of X will allow further increasing the font size.

If this image frame does not contain a subtitle, the subtitle detector 42 will forward this image frame to a layout builder 43, which will generate a frame that contains a corresponding subtitle (a subtitle frame) using the subtitle that was generated by the text to subtitles module 39. Then the layout builder 43 merges the subtitle frame with the image frame and forwards the merged frame to a synchronization module 44 which synchronizes between each group of Y merged frames and their corresponding audio time slice by introducing a the desired delay to the corresponding audio time slice before outputting it. Such a delay is desired, in order to compensate for the delay of the video content resulting from processing the audio signal, converting it to text, translating and generating and adding the subtitles. Alternatively, if the CPU is sufficiently fast, in some cases synchronization will be carried out by introducing some delay to the video channel. The decision which channel should be delayed will depend on the type of buffers and processing speed and may be subjected to the user's configuration.

If this frame already contains a subtitle, no subtitles are needed in this frame and in this case, the subtitle detector 42 will forward the original image frames directly to the synchronization module 44 (while bypassing the layout builder). Finally, the synchronization module 44 outputs both the audio signal 45 (with or without a delay) and the composite video signal 46 to the TV monitor.

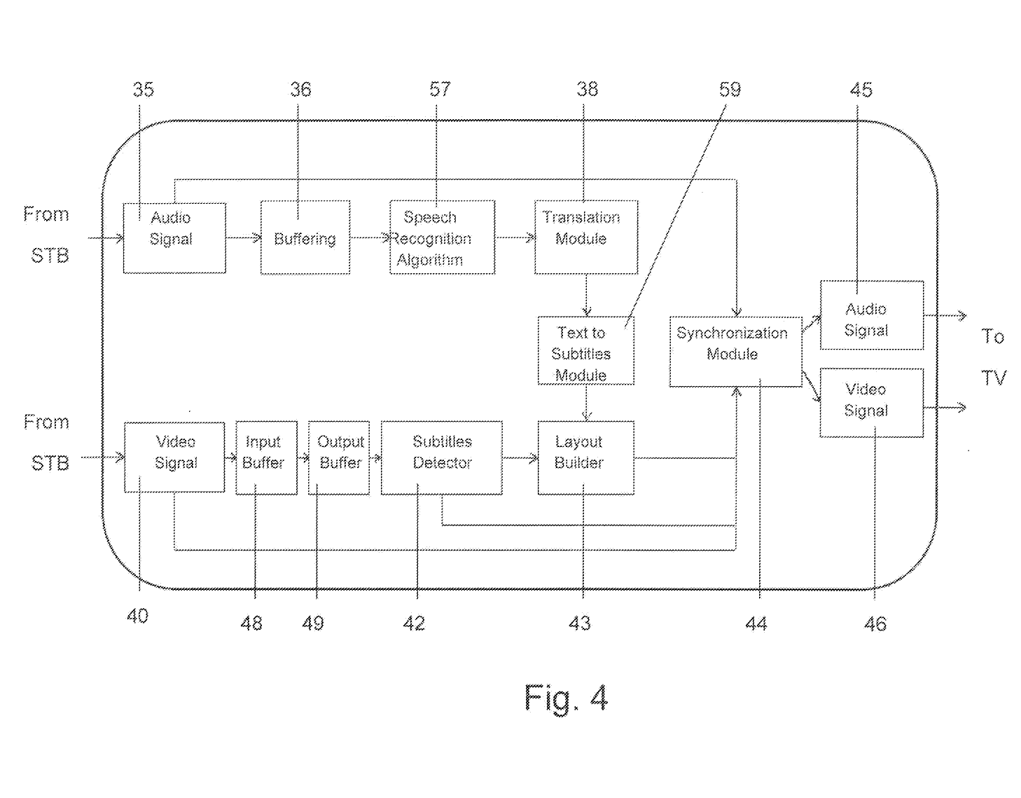

In the embodiment of FIG. 4, the video signal 40 received from the STB is forwarded to an input video buffer 48 and then to an output buffer 49. The total delay time for which the video signal 40 is temporarily stored in both the input video buffer 48 and output buffer 49, e.g. no more than 5 seconds, is sufficient to generate subtitle frames and to merge the generated subtitle frames with the video signal. Video signals outputted by the input video buffer 48 to the output video buffer 49 flow concurrently to the transmission of additional video signals inputted to the input video buffer 48, to achieve a continuous stream. The video signals outputted by the output video buffer 49 are received by the subtitle detector 43, the operation of which is identical to the description hereinabove.

The CPU may regulate the relative time that the video signal 40 is temporarily stored in the input video buffer 48 and the output buffer 49, in response to the operation of the speech recognition module 57. The delay time during which video signals are stored in the input video buffer 48 may be increased relative to the delay time during which they are stored in the output video buffer 49 when it is determined that the current interval of audio signals being converted to text includes a relatively large number of words, i.e. greater than a predetermined threshold, or the rate of word articulation during the current interval is larger than a predetermined threshold. This delay time is sufficient for ensuring that the synchronization module 44 will be able to sufficiently synchronize the transmission to the video monitor of composite frames received from the layout builder 43 with non-processed sound track signals. Conversely, the relative delay time within the input video buffer 48 will be decreased when the current interval of audio signals includes a relatively small number of words, or the rate of word articulation during the current interval is less than a predetermined threshold. The relative delay time within the input video buffer 48 may also be decreased when the processing time of the text to subtitle module 39 is found to be relatively fast.

The speech recognition module 57 and text to subtitle module 59 are configured to minimize processing time and computer resources, as well as to ensure high quality subtitles.

For efficient speech to text conversion, the speech recognition module 57 converts the speech at each predetermined interval of audio signals 35. An empty text field may be outputted if no speech has been detected. Since the detected speech is converted at each predetermined interval of audio signals 35, regardless of whether the end of an interval coincides at the end or in the middle of a word, the speech recognition module 57 is liable to convert cut words, resulting in the generation of subtitles that include incomplete words. In order to avoid such a situation, the CPU subdivides the audio signals 35 into a plurality of predefined time slices arranged such that neighboring time slices overlap each other by a predetermined duration. A predetermined number of time slices are stored at any given time in audio buffer 36. When the CPU determines that the text generated by the speech recognition module 57 includes cut words, a cut word from a first time slice is transferred to, and combined with, a cut word of a second time slice that neighbors and overlaps the first time slice. The CPU commands the text to subtitle module 59 to assign a combined cut word to either of the first or second time slice, depending on predetermined instructions, so that only complete words will be displayed on the corresponding subtitle frame to be generated thereby.

To minimize the processing time resulting from the need of scanning overlapping time slices, the overlapping time of neighboring time slices is limited to a predetermined duration of more than one half of a maximum articulation time for articulating the longest word in the source language that has been processed until the present time in the received audio signals 35, and less than an upper limit of approximately three-quarters of the maximum articulation time. The speech recognition module 57 may be provided with a learning mechanism to update the maximum articulation time. A default maximum articulation time for the source language may be initially assigned.

While some embodiments of the invention have been described by way of illustration, it will be apparent that the invention can be carried out with many modifications, variations and adaptations, and with the use of numerous equivalents or alternative solutions that are within the scope of persons skilled in the art, without departing from the spirit of the invention or exceeding the scope of the claims.

1. A video subtitling hardware device interposed between an audio-visual source and a video display, for automatically adding subtitles in a destination language, to received video signals accompanied by corresponding audio signals associated with a source language, comprising:
a) a CPU for processing a stream of separate audio and video signals which are received from said audio-visual source and are subdivided into a plurality of predefined time slices;
b) an audio buffer for temporarily storing a predetermined number of time slices of said received audio signals which are representative of one or more words to be processed by the CPU, such that neighboring time slices of audio signals outputted by said audio buffer overlap each other by a predetermined duration of more than one half of a maximum articulation time for articulating a longest word of said audio signals in said source language that has been processed until a given time by the CPU in said received stream;
c) a speech recognition module for converting said outputted audio signals to text in said source language, at each predetermined interval of said audio signals;
d) a text to subtitle module for converting said text to subtitles by generating an image containing one or more subtitle frames, each of said subtitle frames including at least one subtitle converted from said text, wherein the CPU is operable to assign combined cut words of said text, if any, to one of a first subtitle frame and a second subtitle frame subsequent to said first subtitle frame while ensuring that only complete words are displayed in said first and second subtitle frames;
e) an input video buffer for temporarily storing each time slice of said received video signals for a sufficient time needed to generate one or more subtitle frames and to merge said generated one or more subtitle frames with said time slice of video signals;
f) an output video buffer for receiving video signals outputted by said input video buffer concurrently to transmission of additional video signals of said stream to said input video buffer, in response to flow of said outputted video signals to said output video buffer;
g) a layout builder for merging one or more of said subtitle frames with a corresponding image frame to generate a composite frame; and
h) a synchronization module for synchronizing between each group of composite frames and their corresponding time slices of a sound track associated with said audio signal before outputting said synchronized composite frame group and audio channel to said video display.

2. The video subtitling device according to claim 1, further comprising:
a) an input video codec for capturing the video signals from the audio-visual source and forwarding them to the CPU, for processing;
b) an input audio codec for capturing the audio signals from the audio-visual source and injecting them to the CPU, for processing;
c) a memory for storing processing results provided by the CPU;
d) an output video codec for capturing the processed video signals that include the added subtitles from the CPU and for transmitting them to the video display; and
e) an output audio codec for capturing the audio signals with or without delay, from said CPU and for transmitting them to said video display, such that both signals are synchronized.

3. A video subtitling device according to claim 2, in which the input video codec is adapted to receive and process video signals in HDMI or DVI formats.

4. A video subtitling device according to claim 2, in which the memory is a flash memory or a hard-disk.

5. A video subtitling device according to claim 1, which is programmed to generate subtitles in predetermined language and appearance.

6. A video subtitling device according to claim 1, further comprising user interface elements for allowing a user to configure the device to operate according to predetermined preferences.

7. A video subtitling device according to claim 6, in which the user preferences include:
destination language;
subtitle font size;
contrast; and
graphical properties of the subtitles.

8. A video subtitling device according to claim 6, in which the user interface includes one or more of the following elements:
a touch screen control unit for controlling the operating menus;
a display for displaying configuring menus and statuses to the user;
a mouse and a keyboard for allowing the user to input and select desired preferences;
an IR controller for allowing the user to control said subtitling hardware device;
a microphone for allowing the user to control said subtitling hardware device by voice commands;
a loudspeaker for playing speech originated from conversion of the subtitles to voice and voice indications during the configuration process of the user; and
a Wi-Fi receiver for:
upgrading versions of the operating software via the internet;
extracting words in destination languages from an external database; and
connecting to an external processing cloud.

9. A video subtitling device according to claim 1, further comprising a memory for storing a database of destination languages.

10. A video subtitling device according to claim 1, further comprising a translation module for generating a corresponding text in a destination language configured by the user.

11. A video subtitling device according to claim 1, further comprising a subtitle detector for detecting if an image frame already contains a subtitle.

12. A video subtitling device according to claim 6, in which the user interface allows determining the time slice duration, according to the desired length of subtitles.

13. A video subtitling device according to claim 1, in which whenever the image frame already contains a subtitle, the original image frames are directly forwarded to the synchronization module while bypassing the layout builder.

14. A video subtitling device according to claim 1, in which the audio-visual source is a set-top box.

15. A video subtitling device according to claim 1, in which the video display is a television.

16. A video subtitling device according to claim 1, in which the predetermined interval during which the audio signals are converted to text is equal to the audio signal time slice that is temporarily stored in the audio buffer.

17. A method for automatically adding subtitles in a destination language, to received video signals accompanied by corresponding audio signals associated with a source language, comprising:
a) processing a stream of separate audio and video signals which are received from said audio-visual source and are subdivided into a plurality of predefined time slices, by a CPU;
b) temporarily storing in an audio buffer, a predetermined number of time slices of said received audio signals which are representative of one or more words to be processed by the CPU, such that neighboring time slices of audio signals outputted by said audio buffer overlap each other by a predetermined duration of more than one half of a maximum articulation time for articulating a longest word of said audio signals in said source language that has been processed until a given time by the CPU in said received stream;
c) converting said outputted audio signals to text in said source language by a speech recognition module, at each predetermined interval of said audio signals;
d) converting said text to subtitles by generating an image containing one or more subtitle frames, each of said subtitle frames including at least one subtitle converted from said text, wherein the CPU is operable to assign combined cut words of said text, if any, to one of a first subtitle frame and a second subtitle frame subsequent to said first subtitle frame while ensuring that only complete words are displayed in said first and second subtitle frames;
e) temporarily storing, in an input video buffer, each time slice of said received video signals for a sufficient time needed to generate one or more subtitle frames and to merge said generated one or more subtitle frames with said time slice of video signals;
f) receiving video signals outputted by said input video buffer, in an output video buffer, concurrently to transmission of additional video signals of said stream to said input video buffer, in response to flow of said outputted video signals to said output video buffer;
g) merging one or more of said subtitle frames with a corresponding image frame to generate a composite frame; and
h) synchronizing between each group of composite frames and their corresponding time slices of a sound track associated with said audio signal before outputting said synchronized composite frame group and audio channel to said video display.
